(19) United States
(12) Patent Application Publication
(10) Pub. No.: US 2026/0264880 A1
(43) Pub. Date: Sep. 10, 2026

(54) CLAMPING DEVICE FOR CLAMPING AT LEAST TWO COMPONENTS OF A STRUCTURE WITH A PREDETERMINED CLAMPING FORCE, AND METHOD FOR ASSEMBLING A STRUCTURE

(71) Applicant: Airbus Operations GmbH, HAMBURG (DE)

(72) Inventor: Dirk STERMANN, HAMBURG (DE)

(21) Appl. No.: 19/554,875

(22) Filed: Mar. 3, 2026

(30) Foreign Application Priority Data
Mar. 4, 2025 (DE) 102025000776.0

(51) Int. Cl. B64F 5/10; B23P 19/04; B32B 38/18

(52) U.S. Cl. CPC B64F 5/10; B32B 38/18; B23P 19/04; B23P 2700/01

(57) ABSTRACT

A clamping device for clamping at least two components of a structure with a predetermined clamping force, particularly in the manufacture of aircraft or spacecraft. Also a method for assembling a structure, particularly in the manufacture of aircraft or spacecraft with such a clamping device. The clamping device utilizes a preloaded force before the components are clamped.

### CROSS-REFERENCES TO RELATED APPLICATIONS

This application claims the benefit of German Patent Application Number 10 2025 000 776.0, filed on Mar. 4, 2025, the entire disclosure of which is incorporated herein by way of reference.

### FIELD OF THE INVENTION

The present invention relates to a clamping device for clamping at least two components of a structure with a predetermined clamping force, particularly in the manufacture of aircraft or spacecraft. Furthermore, the present invention relates to a method for assembling a structure, particularly in the manufacture of aircraft or spacecraft.

### BACKGROUND OF THE INVENTION

Although the invention may be useful in the assembly of various components and/or assemblies in aircraft or spacecraft production, particularly in connections involving the installation of a large number of fasteners and the preparation of corresponding holes, the invention and the underlying problem are below explained by way of example using the assembly of an aircraft fuselage, without limiting the invention thereto.

A conventional method for manufacturing a fuselage structure for an aircraft consists of assembling several essentially barrel-shaped fuselage sections from individual shells by connecting them along joints that extend, for example, approximately parallel to the longitudinal direction of the fuselage, and then joining the assembled sections together along circumferential or orbital joints.

With such a conventional approach, a significant portion of the work, particularly the application of fasteners at the joints, still needs to be performed manually. Automated systems are typically integrated into workstations designed for either longitudinal or orbital joint assembly. This results in a large number of different automated systems integrated into a largely manual workflow, which may lead to automated systems being less efficient than desired.

It would be desirable to be able to manufacture an aircraft in an improved manner suitable for the efficient, automated execution of joining processes at connection points. In the context of aircraft component manufacturing, it has already been proposed to bond parts with a cold- or hot-curing adhesive and, after the adhesive has cured, to drill holes and insert rivets. During the curing process, the parts are typically held in a large, complex, and expensive jig.

Spring-loaded temporary clamping devices are typically used to maintain the clamping force. EP 4 215 444 A1, for example, describes a method for assembling a structure in the manufacture of aircraft or spacecraft, using at least one such clamping device. However, these clamping devices offer only low preload forces and are designed as single-sided fasteners. Such clamping devices require a device at their tip to expand their diameter in order to clamp after insertion into the hole. Furthermore, single-sided fasteners reduce the maximum clamping force because the cross-section of the hole is reduced by at least two parts, only one of which transmits the load.

### SUMMARY OF THE INVENTION

An object of the present invention is to provide a clamping device and a method to precisely effect a clamping force at the connection point of components to be joined and to increase process reliability in the manufacture of aircraft and spacecraft.

According to the invention, this problem may be solved by the subject matter of the various embodiments described herein.

According to a first aspect of the invention, a clamping device is provided for clamping at least two components of a structure with a predetermined clamping force, particularly in the manufacture of aircraft or spacecraft. The clamping device comprises a housing with a longitudinal axis and a pull bar assembly. The pull bar assembly has a free end region and a guided end region. The guided end region is configured to be slidably mounted in the housing along the longitudinal axis. The free end region has a connecting element that is integrally connected to the pull bar assembly or may be connected to it by friction and/or form-fitting means. Furthermore, the connecting element may be fixed relative to the guided end region such that two components of a structure to be connected may be clamped between the housing and the connecting element. The clamping device also includes a spring unit that is arranged in the housing and may be compressed or decompressed by moving the guided end region relative to the housing. The clamping device also includes a linear actuator designed to push the pull rod assembly into a preparation position in which the spring unit is pre-tensioned with a predetermined preload force.

According to a second aspect of the invention, a method for assembling a structure, particularly in the manufacture of aircraft or spacecraft, is provided. The method comprises providing at least two components that are to be joined together at a connection point to form an assembly, each of the components having a connection area.

The associated connection areas are clamped against each other to achieve a clamped state, wherein at least one clamping device is used. The at least one clamping device is designed in particular according to the first aspect of the invention.

The clamping process involves pre-tensioning a spring unit of the at least one clamping device with a predetermined pre-tension force, whereby a pull rod assembly of the at least one clamping device is pressed into a preparation position.

The clamping also includes fixing a connecting element of the pull rod assembly in relation to a guided end area of the pull rod assembly, so that the associated connecting areas between a housing of the at least one clamping device and the connecting element may be clamped.

The clamping process also involves releasing the spring unit from the preload, whereby the associated connection areas are pressed together in the clamped state with a predetermined clamping force.

One of the underlying ideas of the present invention is to provide a device concept and a method that may clamp components in such a way that a sealant is forced out to cure. The clamping device is suitable for clamping at least two components of a structure with a predetermined clamping force. The available tensile force of the pull rod assembly may be effectively utilized to achieve a secure clamp. The pull rod assembly extends along the longitudinal axis and is slidably mounted relative to the housing. By way of example, the guided end region of the pull rod assembly has a support element, in particular a piston plate or similar, which supports the spring unit.

According to the present invention, the predetermined clamping force, starting from the preload force of the spring unit, may be precisely achieved by tensioning the pull rod assembly. The predetermined clamping force may be applied, in particular, by the elastic forces of the spring unit. A reduction in distance due to component yielding, for example, due to deformation, at the connection point may be tolerated. Therefore, the clamping device does not need to be retightened, as the pull rod assembly is spring-loaded by the spring unit. Furthermore, a higher force and/or a longer service life may be provided, since no torque increases the load on the pull rod assembly. The connecting element and/or the linear actuator may be actuated with simple torque tools. The purpose of the linear actuator is to move objects along a straight axis, in this case, along the longitudinal axis.

A further advantage of the present invention is that the pull rod assembly does not require lubrication, particularly to achieve a preload of 6 kN with a UNF 5-44 thread. Lubrication may be applied to the guided end section of the pull rod assembly and/or the linear actuator. Furthermore, the operator's fingers or gloves remain clean. Additionally, the clamping device according to the invention may be operated by a single user, eliminating the need for cooperation between multiple users.

A further advantage is that expensive torque tools may be avoided, the influence of friction on the final preload result is eliminated, particularly regardless of contamination, and process stability is increased or maintained. In particular, no retightening is required when using the present invention. The clamping device according to the invention may be installed by a single person in a two-sided operation, especially in combination with an assembly aid. The invention was developed to achieve the best possible setup process.

The accuracy of the clamping force possibly achieved by fixing the fastener may be negligible compared to the predetermined clamping force or the total clamping force result in the clamped state.

According to one embodiment of the present invention, the pull rod assembly has a tensile strength of about (+/−10%) 1,900 MPa or more. In particular, the pull rod assembly may have a tensile strength of about 2,000 MPa or more. For example, the pull rod assembly may be made of a steel alloy or similar material.

The pull rod assembly may, for example, be designed in multiple parts. At least the guided end section or the free end section may have a component of the pull rod assembly, in particular the connecting element, which is designed to be reversibly attached to a remaining part of the pull rod assembly.

The clamping device—in particular the housing, the pull rod assembly and/or the spring unit—may be designed to be essentially rotationally symmetrical or axially symmetrical.

According to a further embodiment of the present invention, the pull rod assembly has an external thread at least in sections. Using the pull rod assembly, clamping forces, for example the predetermined clamping force, may be achieved precisely without the need to clean the external thread. By way of example, the pull rod assembly may be designed as a threaded rod or as a screw with the connecting element designed as a screw head.

Alternatively or additionally to the external thread, the pull rod assembly may have at least one groove. The connecting element may have a complementary fastening counterpart to the pull rod assembly, or be designed as such, to provide the friction-fit and/or positive-locking connection. The friction-fit and/or positive-locking connecting element may, for example, be designed as a screw nut, a combination nut, or a fastening clip. Large tool through-holes may be created using a combination nut as a fastener. The combination nut thus enables convenient and easy insertion, regardless of part tolerances.

According to a further development of the present invention, the clamping device also comprises a spring assembly which may be compressed to check the initial position of the connecting element by screwing the connecting element in using the external thread. In this way, the spring assembly may be compressed in the initial position and indicate to the user, by means of a designated marking, that the initial position has been reached. The spring assembly may, for example, comprise a single coil spring arranged concentrically with respect to the pull bar assembly, or it may comprise several coil springs arranged around the pull bar assembly.

The linear actuator may, for example, convert the rotary motion of a DC motor into a linear motion.

According to a further embodiment of the present invention, the linear actuator is designed as an actuating screw that may be displaced along its longitudinal axis by turning it relative to the housing. Thus, the linear actuator may be operated manually and without an additional power source. Furthermore, the actuating screw may provide a self-locking mechanism so that the spring unit may be held in the ready position without requiring an active power source to maintain the predetermined preload force for the linear actuator.

An intermediate section of the pull rod assembly may be guided slidably at an opening in the housing.

According to a further embodiment of the present invention, the guided end region in the prepared position is in contact with a stop element of the housing, the stop element being positioned such that the spring unit is compressed, based on its spring characteristic curve, by the displacement of the guided end region relative to the housing which produces the predetermined preload force. The predetermined preload force may be achieved via the elastic modulus of a material, for example, an elastomer, from which the spring unit is formed, or via at least one helical spring or comparable spring. The spring unit may, for example, be designed as a helical spring, which is arranged concentrically, particularly with respect to the pull rod assembly. Alternatively or additionally, the spring unit may comprise an elastomer. The predetermined clamping force may be calculated from the spring rate or spring characteristic curve, taking into account the operating point in an initial state of the spring unit, a compression stroke of the connecting element, and an elongation of the pull rod assembly.

As an alternative to the housing's stop, the spring unit may be compressed by a stop on the linear actuator against the housing or against a stop ring positioned between the housing and the linear actuator. This compression, based on the spring characteristic curve, is achieved by the displacement of the guided end section relative to the housing that produces the predetermined preload force. The stop ring may be made of a metallic material, particularly steel. The stop ring offers an alternative to a washer for adjusting the spring unit to the predetermined preload force in the ready position, thus serving as the sole stop. Specifically, the linear actuator, designed as an actuating screw, may be screwed into the stop ring until it reaches its stop to achieve the ready position. Optionally, the stop ring may be provided together with the stop, in which case the stop ring is made of plastic to prevent over-constraint.

Optionally, the clamping device may include a visualization feature to indicate the correct, predetermined preload force. This visualization feature could, for example, be a color-coded marker that is not visible to the user when the correct, predetermined preload force is applied. Before the linear actuator releases or yields, the assembly should be in a geometrically defined state.

Alternatively or additionally, the clamping device may include a visualization feature to indicate that the spring unit is fully relaxed. For example, the linear actuator may have this visualization feature, particularly in the form of a color-coded indicator, which is clearly visible to the user when the spring unit is fully relaxed.

According to a further embodiment of the present invention, the guided end region is coupled to the linear actuator via a rotatable disc assembly. For example, an axial needle bearing may be arranged between the rotatable disc assembly and the guided end region of the pull rod assembly to reduce wear, wherein the disc assembly is rotatable relative to the guided end region or to the housing. For example, the actuating screw may press against the rotatable disc assembly, thereby holding the pull rod assembly in the housing.

Furthermore, the housing may have a reversibly opening cover. The cover may, for example, be located at an end section of the housing along its longitudinal axis and be dimensioned such that the pull rod assembly may be removed from or installed in the housing. This allows the pull rod assembly to be detached from the housing, particularly for maintenance or replacement. The cover may be attached to the housing using a force-fit connection, such as a screw connection.

According to a further embodiment of the present invention, the clamping device further comprises an assembly aid that may be fixed to one of the two components to be joined. The assembly aid is designed to be positively connected to the housing in order to restrict the housing's freedom of movement in the direction of its longitudinal axis in the event of a fault. This prevents the housing from springing away due to the pre-tensioned spring unit in the event of a fault, for example, a breakage of the pull rod assembly. The positive connection between the assembly aid or jig and the housing may be established, for example, by means of a bayonet fitting. In particular, the housing may have a positive locking element projecting perpendicular to the longitudinal axis, which may be inserted into an angled groove of the assembly aid.

For example, the assembly aid may comprise a plurality of spring-loaded force application elements, wherein the assembly aid is designed to transmit the clamping force, in particular the predetermined clamping force, to the at least two components via the plurality of spring-loaded force application elements. The spring loading of the force application elements may be achieved via the modulus of elasticity of a material, for example, an elastomer, from which the plurality of spring-loaded force application elements are formed, or via a compression spring or other spring device. The clamping forces may be adjusted, for example, by selecting compression springs with different spring rates or spring characteristics, or elastomers with different moduli of elasticity, or a combination thereof, for different force application elements. This helps to apply different clamping forces in a connection area, in particular along a single assembly aid, as required.

Optionally, the clamping device may be equipped with a damping ring for energy absorption in the event of a fault. The damping ring may be positioned between the guided end section and the housing along its longitudinal axis. For example, the damping ring may be made of a plastic material.

For example, a washer may be provided to adjust the predetermined preload force in the preparation position, with the washer in contact with the spring unit. This reduces deviations due to spring tolerances.

According to a further embodiment of the present invention, the spring unit is pre-tensioned by means of a linear actuator designed as an actuating screw, which is displaceable along the longitudinal axis by rotation relative to the housing, wherein the actuating screw is rotated in a torque-controlled or torque-monitored manner, or in an angle-controlled or angle-monitored manner. This ensures that the actuating screw is displaced sufficiently far along the longitudinal axis.

For example, the spring unit may be pre-tensioned by means of a linear actuator. Pre-tensioning the spring unit compresses it to a force of approximately 7000 N to approximately 12000 N, preferably approximately 9000 N. This causes a downward stroke of the pull rod assembly, which, for example, covers the visual indicator used to show the complete relaxation of the spring unit. The visual indicator may also, for example, work in conjunction with the stop ring.

According to a further embodiment of the present invention, the method further comprises: before the fastener is disassembled, re-tensioning the spring unit of the at least one clamping device with the predetermined preload force in order to relieve the tension on the pull rod assembly. In this way, the predetermined clamping force acting on the pull rod assembly may be reduced or eliminated, since otherwise it is hardly possible to remove the fastener, in particular to remove the nut with a conventional torque.

According to a further development of the present invention, the method further comprises: disassembling the connecting element with respect to the guided end region of the pull rod assembly, wherein the pull rod assembly is held in the preparation position. This means that, to disassemble, the linear actuator must push the pull rod assembly into the preparation position, in particular, the actuating screw must be screwed in until it reaches the stop of the housing. The correct preparation position may be checked by the maximum torque of the actuating screw, by the position of the actuating screw, or by a recess in the housing. After disassembling the connecting element, the at least one clamping device may be used in the next application. In particular, the spring unit may remain pre-tensioned with the predetermined preload force after disassembling the connecting element, with the pull rod assembly held in the preparation position.

According to a further embodiment of the present invention, the pull rod assembly penetrates a recess in the at least two components in the connection area. The recess allows for the transmission of maximum force, utilizing most of its available cross-section. For example, the pull rod assembly may withstand a load of approximately 6.5 kN when using a UNF5-44 thread, with the pull rod assembly penetrating a recess with a diameter of approximately 3.3 mm.

According to a further embodiment of the present invention, the pull rod assembly is installed in an assembly aid, which is fixed to one of the components to be joined. The assembly aid is designed to be positively connected to the housing in order to restrict the housing's freedom of movement along its longitudinal axis in the event of a failure. This prevents the housing from springing away due to the pre-tensioned spring unit in the event of a failure, for example, a breakage of the pull rod assembly. The housing may be rotated about its longitudinal axis to establish a positive connection between the assembly aid and the housing. The positive connection between the assembly aid and the housing may be established, for example, by means of a bayonet fitting or a thread.

In particular, the housing may have a positive locking element projecting perpendicular to its longitudinal axis, which may be inserted into an angled groove of the mounting aid, for example, by rotating the housing by 90° or less. This means the housing may be rotated a quarter turn or less to fully lock it in the mounting aid and allow further insertion to install the fastener. The positive locking element may prevent rotation of the housing during torque operations of the fastener and/or linear actuator. For example, the angled groove may be designed such that the housing may first be inserted into the mounting aid along its longitudinal axis, then rotated, and then inserted further along its longitudinal axis. In this way, the free end of the housing only protrudes from the components to be joined after the housing has been rotated relative to the mounting aid and inserted further along its longitudinal axis. This ensures that the housing is securely mounted in the mounting aid.

According to a further embodiment of the present invention, the method further comprises: applying a sealant, an adhesive, or a liquid shim to at least one of the components in its joint area. The liquid shim is a pasty material consisting of resin and a hardener.

Furthermore, the method may include: forming an arrangement by positioning the components relative to each other, whereby an uncured layer of sealant, adhesive or liquid shim is formed between the associated connection areas; and maintaining the clamped state of the associated connection areas at least until the layer of sealant, adhesive or liquid shim between and in contact with the associated connection areas has cured to a predefined degree, wherein the clamping device is installable and transportable together with the arrangement.

Once the layer of sealant, adhesive, or liquid shim has cured at least to a predefined degree, at least a plurality of fastening positions may be drilled within the joint areas to create a hole of final dimensions at each of these fastening positions. Furthermore, a final fastener may be installed at each of these fastening positions. This occurs when the sealant, adhesive, or liquid shim has cured to a predefined degree, corresponding to a cure level at which the sealant, adhesive, or liquid shim no longer flows and, without external mechanical action, the joint areas remain unchanged in their spatial arrangement relative to each other at the predefined cure level.

The assembly aid may comprise a first assembly aid part, arranged on a first side of the joint and suitable for applying a multitude of individual forces acting from that first side, and a second assembly aid part, designed as a common rigid counter bearing part and arranged on a second side of the joint opposite the first side. In some embodiments, a single common rigid counter bearing part on the second side may be sufficient to achieve the desired sealant layer thickness after curing.

The above embodiments and further developments may be combined with one another as appropriate. In particular, all features of the device are transferable to the associated method, and vice versa. Further possible embodiments, further developments, and implementations of the invention also include combinations of features of the invention described previously or subsequently with respect to the exemplary embodiments, even if not explicitly mentioned. In particular, those skilled in the art will also add individual aspects as improvements or additions to the respective basic form of the present invention.

### BRIEF DESCRIPTION OF THE DRAWINGS

The present invention is explained in more detail below with reference to exemplary embodiments and the accompanying figures. The figures show:

FIG. 1 shows a schematic sectional view of a clamping device for clamping at least two components of a structure with a predetermined clamping force, particularly in the manufacture of aircraft or spacecraft, according to an embodiment of the invention;

FIG. 2 shows a schematic sectional view of a clamping device for clamping at least two components of a structure with a predetermined clamping force, particularly in the manufacture of aircraft or spacecraft, according to a further embodiment of the invention;

FIG. 3 shows a schematic sectional view of a clamping device for clamping at least two components of a structure with a predetermined clamping force, particularly in the manufacture of aircraft or spacecraft, according to a further embodiment of the invention, wherein the clamping device has an assembly aid with spring-loaded force application elements;

FIG. 4 shows a schematic sectional view of the clamping device from FIG. 3, wherein the assembly aid further comprises a second assembly aid part ;

FIG. 5 shows a schematic sectional view of the clamping device from FIG. 4, wherein the second assembly aid also has spring-loaded force introduction elements;

FIG. 6 shows a schematic sectional view of the clamping device from FIG. 5, in which the clamping device is in a preparation position;

FIG. 7 shows a schematic sectional view of the clamping device from FIG. 5, wherein the connecting means of the pull rod assembly is fixed in relation to the guided end area of the pull rod assembly;

FIG. 8 is a schematic sectional view of the clamping device from FIG. 5, showing the clamping device and the two components in the clamped state; and

FIG. 9 shows a flowchart of a method for assembling a structure, particularly in the manufacture of aircraft or spacecraft according to a further embodiment of the invention.

### DETAILED DESCRIPTION OF THE PREFERRED EMBODIMENTS

In the figures of the drawing, identical, functionally equivalent and similarly acting elements, features and components—unless otherwise stated—are each provided with the same reference symbols.

Although specific embodiments and further developments are presented and described herein, the person skilled in the art will prefer that a multitude of alternative and/or similar embodiments may replace the specific embodiments presented and described without departing from the scope of the present invention. This application is intended to generally cover all variations or modifications of the specific embodiments described herein.

The accompanying figures are intended to provide a further understanding of embodiments of the invention and serve, in conjunction with the description, to explain the principles and concepts of the invention. Other embodiments and many of the advantages mentioned will become apparent with regard to the drawings. The drawings are to be understood merely as schematic drawings, and the elements of the drawings are not necessarily shown to scale. Directional terminology such as “above”, “below”, “left”, “right”, “over”, “under”, “horizontal”, “vertical”, “front”, “back” and similar terms are used for explanatory purposes only and do not serve to restrict the general public to specific configurations as shown in the figures.

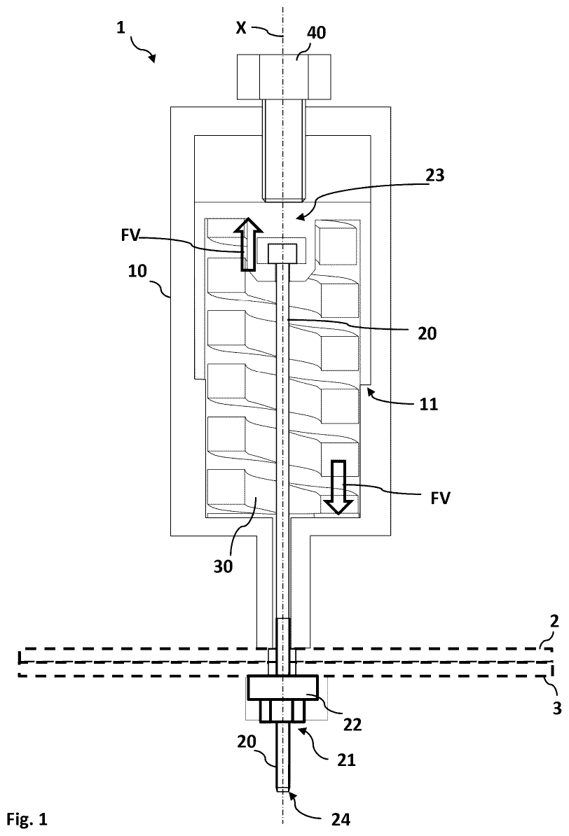

FIG. 1 shows a schematic sectional view of a clamping device 1 for clamping at least two components 2, 3 of a structure with a predetermined clamping force, particularly in the manufacture of aircraft or spacecraft, according to an embodiment of the invention.

The clamping device 1 includes, for example, a housing 10 with a longitudinal axis X, a pull rod assembly 20, a spring unit 30 and a linear actuator 40.

The pull rod assembly 20 has a free end section 21 and a guided end section 23. The pull rod assembly 20 extends, by way of example, along the longitudinal axis X and is slidably mounted relative to the housing 10. The guided end section 23 is designed to be slidably mounted in the housing 10 along the longitudinal axis X. The free end section 21 has a connecting element 22, which may be connected to the pull rod assembly 20 by frictional and/or positive locking. By way of example, the guided end section 23 of the pull rod assembly 20 has a support element, in particular a piston plate or similar, which supports the spring unit 30.

The connecting element 22 may be fixed in relation to the guided end region 23 in such a way that two components 2, 3 of a structure to be connected may be clamped between the housing 10 and the connecting element 22, as shown in FIG. 1.

The pull rod assembly 20 may, for example, be designed in multiple parts. At least the guided end region 23 or the free end region 21 may have a component of the pull rod assembly 20 that is reversibly attachable to a remainder of the pull rod assembly 20. In FIG. 1, the component that is reversibly attachable to the remainder of the pull rod assembly 20 corresponds to the connecting element 22.

For example, the pull rod assembly 20 may have an external thread 24, at least in some sections. By way of example, the pull rod assembly 20 may be designed as a threaded rod. Here, the pull rod assembly 20 includes, by way of example, the external thread 24 in the free end region 21, wherein the connecting element 22 is designed as a complementary fastening counterpart to the pull rod assembly, for example as a combination nut, in order to provide the friction-fit and/or positive-fit connection.

Furthermore, the housing 10 may have a contact shoulder for contact with one of the two components 2, 3. The contact shoulder may clamp the two components 2, 3 between itself and the connecting element 22.

The spring unit 30 is arranged in the housing 10 and can be compressed or decompressed by displacing the guided end section 23 relative to the housing 10, depending on whether the linear actuator 40 presses the guided end section 23 downward or allows it to slide upward. The spring unit 30 may, for example, be designed as a single helical spring, which in this exemplary embodiment is arranged concentrically with respect to the pull-rod assembly 20. However, the spring unit is not limited to a single helical spring or the like; instead, it may alternatively comprise multiple helical springs arranged around the pull-rod assembly 20 or around the longitudinal axis X. Alternatively or additionally, the spring unit 30 may include an elastomer.

The linear actuator 40 is designed to press the pull rod assembly 20 into a pre-tensioned position in which the spring unit 30 is pre-tensioned with a predetermined preload force FV. This pre-tensioned position is shown in FIG. 1. For example, the linear actuator 40 may be designed as an actuating screw that is displaceable along the longitudinal axis X by turning it relative to the housing 10. By screwing in the actuating screw 40, the guided end section 23 may be displaced within the housing 10. In the pre-tensioned position, the guided end section 23 may be in contact with a stop element 11 of the housing 10, as illustrated in FIG. 1. The stop element 11 is positioned, for example, such that the spring unit 30 is compressed, based on its spring characteristic curve, by the displacement of the guided end section 23 relative to the housing 10 that results in the predetermined preload force FV.

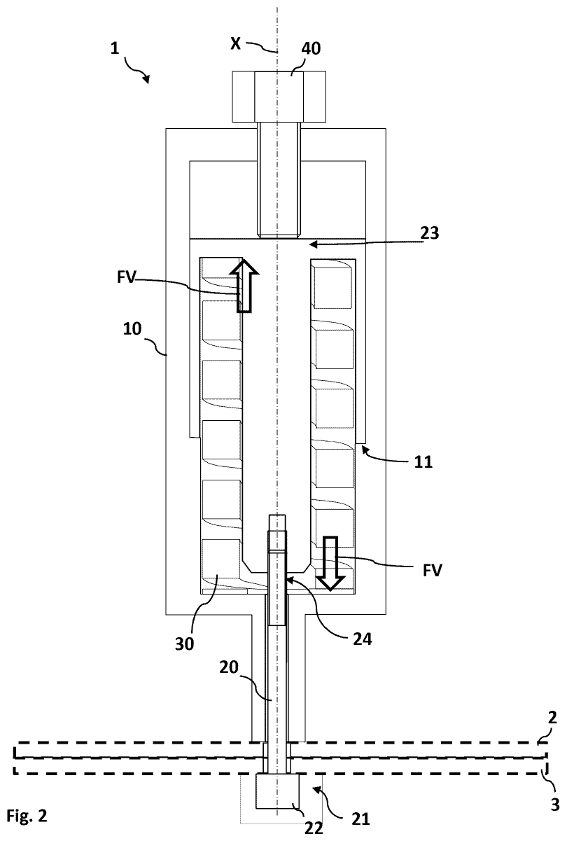

FIG. 2 shows a schematic sectional view of a clamping device 1 for clamping at least two components 2, 3 of a structure with a predetermined clamping force, particularly in the manufacture of aircraft or spacecraft, according to a further embodiment of the invention.

The clamping device 1 includes, for example, a housing 10 with a longitudinal axis X, a pull rod assembly 20, a spring unit 30 and a linear actuator 40.

The pull rod assembly 20 has a free end section 21 and a guided end section 23. The pull rod assembly 20 extends along the longitudinal axis X and is slidably mounted relative to the housing 10. The guided end section 23 is designed to be slidably mounted within the housing 10 along the longitudinal axis X. The free end section 21 has a connecting element 22, which is integrally connected to the pull rod assembly 20. For example, the pull rod assembly 20 may have an external thread 24, at least partially. Alternatively, the pull rod assembly 20 may be designed as a screw with the connecting element 22 configured as a screw head. Consequently, the screw may be inserted through the two components 2 and 3 to be connected and into the housing 10, where the screw is tightened against the guided end section 23 via the external thread 24. For example, the guided end region 23 of the pull bar assembly 20 has a piston plate which has an internal thread for screwing in the pull bar assembly 20 and supports the spring unit 30.

The connecting element 22 may be fixed in relation to the guided end region 23 in such a way that two components 2, 3 of a structure to be connected may be clamped between the housing 10 and the connecting element 22, as shown in FIG. 2.

The spring unit 30 is arranged in the housing 10 and can be compressed or decompressed by displacing the guided end section 23 relative to the housing 10, depending on whether the linear actuator 40 presses the guided end section 23 downward or allows it to slide upward.

The linear actuator 40 is configured to press the pull rod assembly 20 into a pre-tensioned position in which the spring unit 30 is pre-tensioned with a predetermined pre-tension force FV. This pre-tensioned position is shown in FIG. 2.

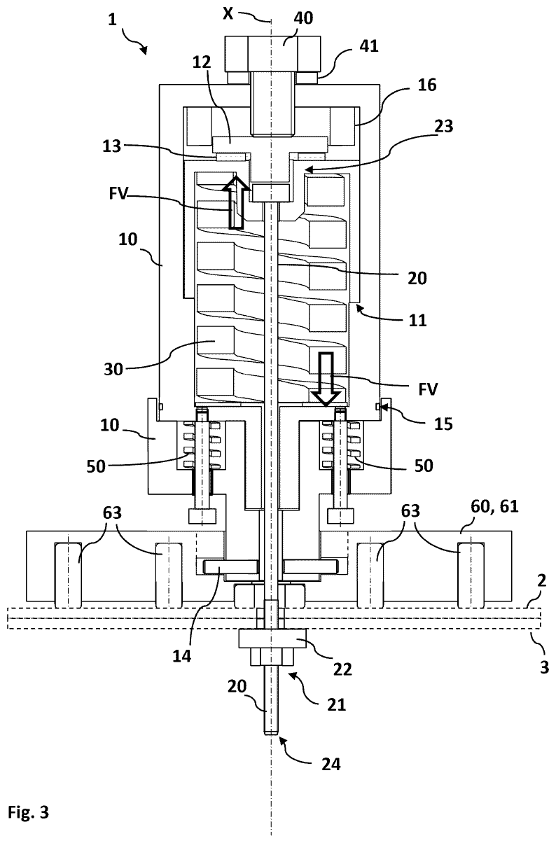

FIG. 3 shows a schematic sectional view of a clamping device 1 for clamping at least two components 2, 3 of a structure with a predetermined clamping force, particularly in the manufacture of aircraft or spacecraft, according to a further embodiment of the invention, wherein the clamping device 1 has an assembly aid 60 with spring-loaded force introduction elements 63.

The clamping device 1 includes, for example, a housing 10 with a longitudinal axis X, a pull rod assembly 20, a spring unit 30, a linear actuator 40, a spring assembly 50 and the assembly aid 60.

The pull rod assembly 20 has a free end section 21 and a guided end section 23. The guided end section 23 is designed to be slidably mounted in the housing 10 along the longitudinal axis X. The free end section 21 has a connecting element 22 which may be frictionally and/or positively connected to the pull rod assembly 20. For example, the pull rod assembly 20 may have a tensile strength of approximately 1900 MPa or more. In particular, the pull rod assembly 20 may have a tensile strength of approximately 2000 MPa or more. For example, the pull rod assembly 20 may be made of a steel alloy or similar material.

The connecting element 22 may be fixed in relation to the guided end region 23 such that two components 2, 3 of a structure to be connected may be clamped between the housing 10 and the connecting element 22. Specifically, in addition to the two components 2, 3 to be connected, at least one section of the assembly aid 60 may also be clamped between the housing 10 and the connecting element 22, as is shown by way of example in FIG. 3.

At least the guided end region 23 or the free end region 21 may have a component of the pull rod assembly 20 that is reversibly attachable to a remainder of the pull rod assembly 20. In FIG. 3, the component that is reversibly attachable to the remainder of the pull rod assembly 20 corresponds to the connecting element 22.

For example, the pull rod assembly 20 may have an external thread 24, at least in some sections. By way of example, the pull rod assembly 20 may be designed as a threaded rod. Here, the pull rod assembly 20 includes, by way of example, the external thread 24 in the free end region 21, wherein the connecting element 22 is designed as a complementary fastening counterpart to the pull rod assembly, for example as a screw nut, in order to provide the friction-fit and/or positive-locking connection.

The spring unit 30 is arranged in the housing 10 and can be compressed or decompressed by displacing the guided end section 23 relative to the housing 10, depending on whether the linear actuator 40 presses the guided end section 23 downward or allows it to slide upward. The spring unit 30 may, for example, be designed as a helical spring, which in this exemplary embodiment is arranged concentrically with respect to the pull-rod assembly 20.

The linear actuator 40 is designed to press the pull rod assembly 20 into a pre-tensioned position in which the spring unit 30 is pre-tensioned with a predetermined preload force FV. This pre-tensioned position is shown in FIG. 3. For example, the linear actuator 40 may be designed as an actuating screw that is displaceable along the longitudinal axis X by turning it relative to the housing 10. By screwing in the actuating screw 40, the guided end section 23 may be displaced within the housing 10. In the pre-tensioned position, the guided end section 23 may be in contact with a stop element 11 of the housing 10, as illustrated in FIG. 3. The stop element 11 is positioned, for example, such that the spring unit 30 is compressed, based on its spring characteristic curve, by the displacement of the guided end section 23 relative to the housing 10 that results in the predetermined preload force FV. Additionally, a stop ring 41 may be provided as an indicator for the correct preload of the spring unit 30. The stop ring 41 may be arranged between the housing 10 and the linear actuator 40, in particular the actuating screw, and serves to visualize the achieved preparation position. Alternatively to the stop element 11, the stop ring may be used to compress the spring unit 30, based on its spring characteristic curve, by the displacement of the guided end section 23 relative to the housing 10 which produces the predetermined preload force FV.

The housing 10 may comprise an upper housing part and a lower housing part, which are slidable relative to each other along the longitudinal axis X. The two housing parts may be guided radially relative to each other.

Furthermore, the spring assembly 50 may be compressed to check the initial position of the connecting element 22 by screwing the connecting element 22 in place using the external thread 24. In this way, the spring assembly 50 may be compressed in the initial position, indicating to a user that the initial position has been reached by means of a designated marking. The spring assembly 50 may couple the upper housing part with the lower housing part and, in particular, influence their relative displacement. The spring assembly 50 may, for example, comprise several compression springs or coil springs arranged around the longitudinal axis X and each aligned parallel to the longitudinal axis X.

Optionally, the clamping device 1 may have a visual indicator 15 to indicate the correct minimum holding force. The visual indicator 15 may, for example, be a color-coded marking that is not visible to the user when the correct minimum holding force is present. Before the linear actuator 40 releases or yields, the assembly should be in a geometrically defined state. The minimum holding force may be achieved by tightening the combination nut 22 to the pull rod assembly 20. The minimum holding force may, for example, be approximately 400 N, at which point the spring assembly 50 compresses and the visual indicator 15 is obscured.

Furthermore, the clamping device 1 may comprise a rotatable disc assembly 12, wherein the guided end region 23 is coupled to the linear actuator 40 via the rotatable disc assembly 12. For example, an axial needle bearing 13 may be arranged between the rotatable disc assembly 12 and the guided end region 23 of the pull rod assembly 20 to reduce wear, wherein the disc assembly 12 is rotatable relative to the guided end region 23 or to the housing 10, in particular about the longitudinal axis X. For example, the actuating screw 40 may press on the rotatable disc assembly 12, whereby the actuating screw 40 holds the pull rod assembly 20 in the housing 10. The disc assembly 12 may, for example, have a projection in the direction of the longitudinal axis X in order to be radially guided by the guided end region 23, in particular by the piston plate.

Furthermore, the housing 10 may have a reversibly opening cover (not shown). The cover may, for example, be arranged at an end section of the housing 10 along the longitudinal axis X and be dimensioned such that the pull rod assembly 20 may be removed from or installed in the housing 10. This allows the pull rod assembly 20 to be detached from the housing 10, particularly for maintenance or replacement. The cover may be mounted to the housing 10 by means of a force-fit connection, for example, a screw connection.

The assembly aid 60 may be fixed to one of the two components 2, 3 to be joined, and is designed to be positively connected to the housing 10 in order to restrict the movement of the housing 10 in the direction of the longitudinal axis X in the event of a fault. The assembly aid 60 may have a first assembly component 61, which is arranged on a first side and is suitable for applying a plurality of individual forces acting from the first side. The positive connection between the assembly aid 60 or jig and the housing 10 may be established, for example, by means of a bayonet fitting. In particular, the housing 10 may have a positive locking element 14 projecting perpendicular to the longitudinal axis X, which may be inserted into an angled groove of the assembly aid 60.

As illustrated in FIG. 3, the first assembly aid 61 may comprise a plurality of spring-loaded force application elements 63, wherein the first assembly aid 61 is configured to transmit the clamping force, in particular the predetermined clamping force, via the plurality of spring-loaded force application elements 63 to the at least two components 2, 3. The spring loading of the force application elements 63 may be effected via the modulus of elasticity of a material, for example an elastomer, from which the plurality of spring-loaded force application elements 63 are formed, or via a compression spring or other spring device. The clamping forces may be adjusted, for example, by selecting compression springs with different spring rates or spring characteristics, or elastomers with different moduli of elasticity, or a combination thereof, for different force application elements 63. This helps to apply different clamping forces in a connection area, in particular along the first assembly aid 61, as required. The multitude of spring-loaded force introduction elements 63 may, for example, each be integrated into a recess of the first assembly aid part 61.

Optionally, the clamping device 1 may be equipped with a damping ring 16 for energy absorption in the event of a fault. The damping ring 16 may be arranged between the guided end region 23 and the housing 10 along the longitudinal axis X. For example, the damping ring 16 may be made of a plastic.

For example, a washer may be provided to adjust the predetermined preload force FV in the preparation position, with the washer being in contact with the spring unit 30.

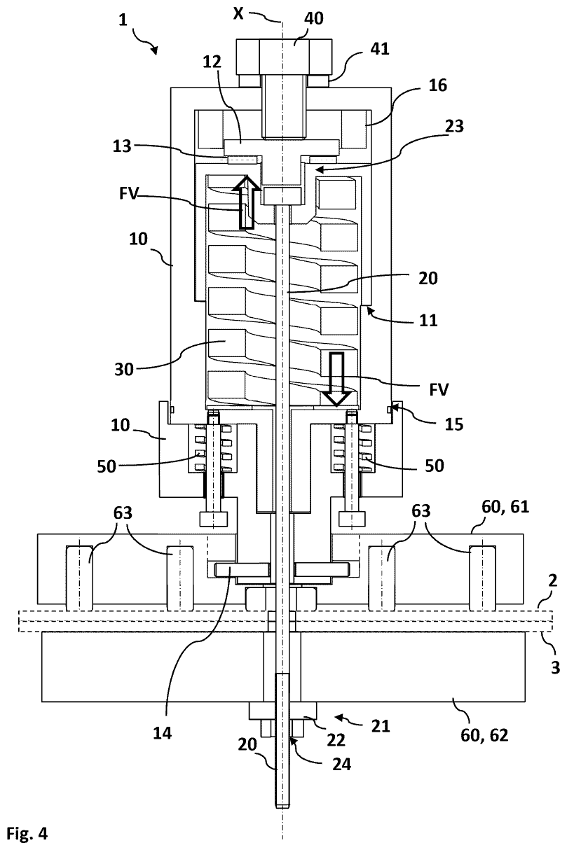

FIG. 4 shows a schematic sectional view of the clamping device 1 from FIG. 3, wherein the assembly aid 60 further comprises a second assembly aid part 62.

The clamping device 1 according to FIG. 4 comprises essentially the same features as the clamping device from FIG. 3. In addition, the assembly aid 60 is shown here, by way of example, equipped with the second assembly aid part 62. The assembly aid 60 may apply a multitude of individual forces acting from the first side by means of the first assembly aid part 61 arranged on the first side. The second assembly aid part 62 may be designed as a common rigid counter bearing part and arranged on a second side opposite the first side. The second assembly aid part 62 may cover approximately the same surface area of the two components 2, 3 as the first assembly aid part 61.

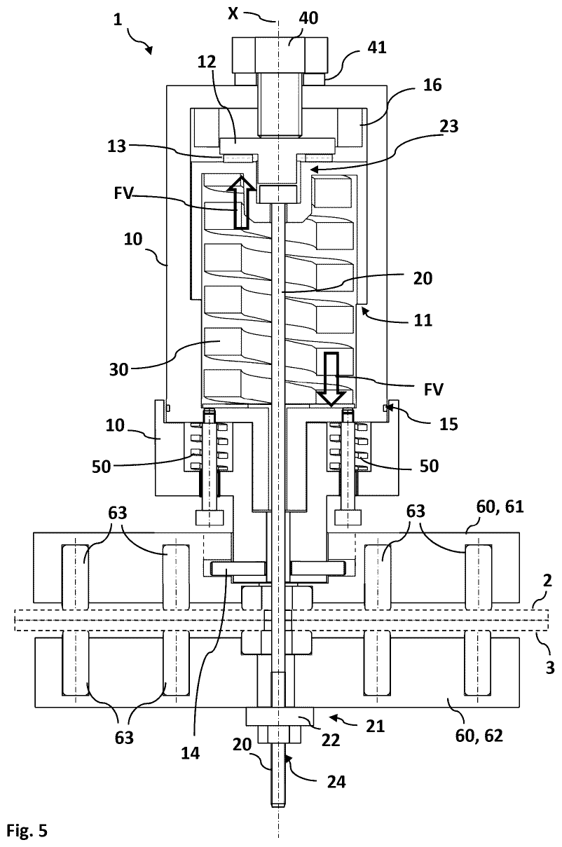

FIG. 5 shows a schematic sectional view of the clamping device 1 from FIG. 4, wherein the second assembly aid 62 also has spring-loaded force introduction elements 63.

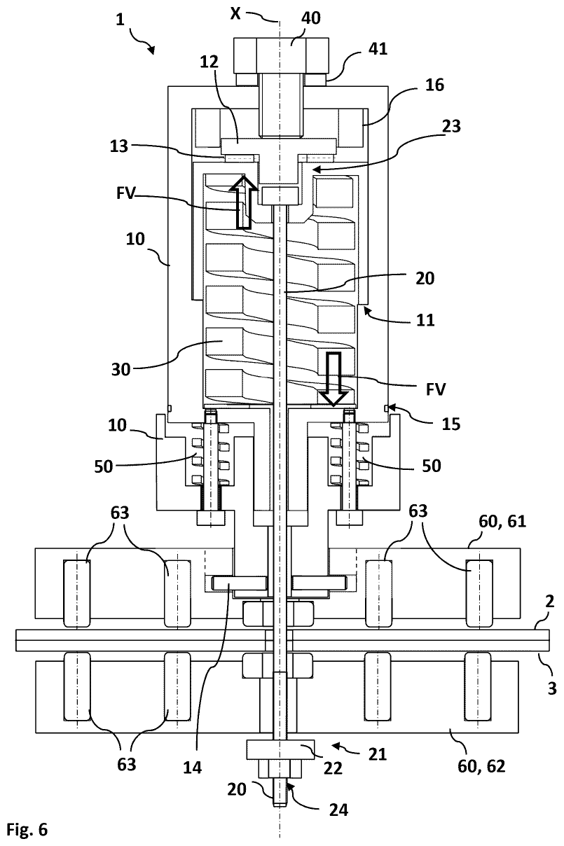

FIG. 6 shows a schematic sectional view of the clamping device 1 from FIG. 5, in which the clamping device 1 is in a preparation position.

Unlike FIG. 5, the upper and lower housing parts are not in full contact with each other, since the connecting element 22 offers no resistance to the spring assembly 50. In this state, the visualizing element 15 may be visible. The clamping device 1 is in the prepared position, as the spring unit 30 is pre-tensioned with the predetermined preload force FV.

FIG. 6 shows an example of the state of the clamping device 1 as it may be after pre-tensioning M3.1 of the spring unit 30 with the predetermined pre-tension force FV. In addition, the pull bar assembly 20 or the housing 10, in particular the lower housing part, has already been installed in this state in the assembly aid 60, in particular in the first assembly aid part 61.

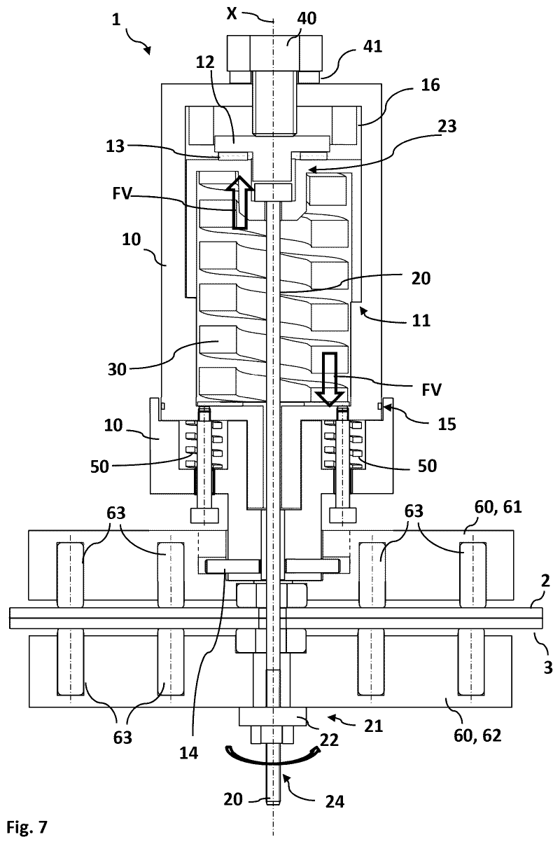

FIG. 7 shows a schematic sectional view of the clamping device from FIG. 5, wherein the connecting element 22 of the pull rod assembly 20 is fixed in relation to the guided end region 23 of the pull rod assembly 20 M3.2.

The semicircular arrow in the area of the free end region 21 visualizes the screwing of the connecting element 22 designed as a screw nut, so that the associated connection areas of the two components 2, 3 between the housing 10 and the connecting element 22, in particular between the first assembly aid 61 and the second assembly aid 62, are clamped.

After fixing the connecting element 22 M3.2 in relation to the guided end region 23, the upper housing part may be in contact with the lower housing part, with the spring assembly 50 compressed. The visualizing element 15 is therefore not visible, as it is covered by a collar section of the lower housing part. Of course, such an overlap may also be achieved the other way around, i.e., by the upper housing part covering the visualizing element 15 arranged on the lower housing part.

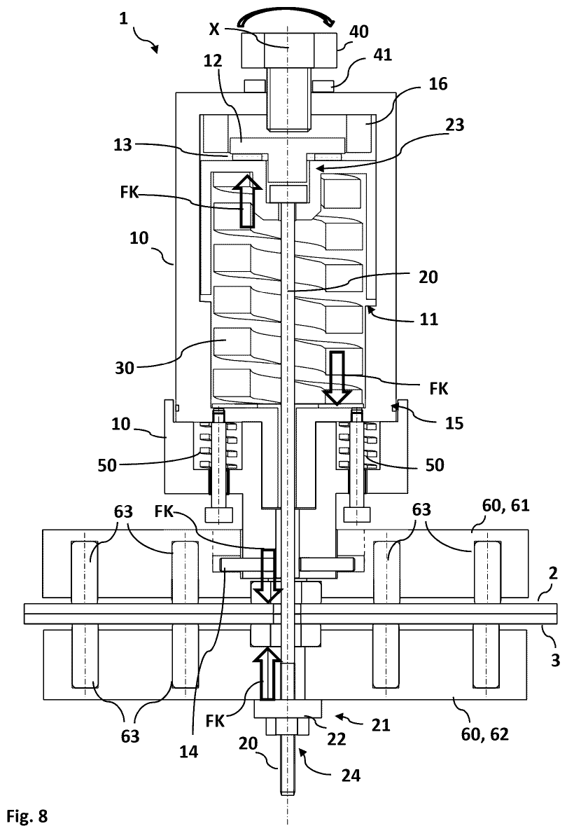

FIG. 8 shows a schematic sectional view of the clamping device 1 from FIG. 5, where the clamping device 1 and the two components 2, 3 are in the clamped state. In the clamped state, the predetermined clamping force FK acts on the two components 2, 3 at the connection point.

The semicircular arrow above the linear actuator 40, which is designed as an actuating screw, visualizes the unscrewing of the actuating screw, so that there is no force transmission from the linear actuator 40 to the guided end area 23.

FIG. 8 shows an example of the clamped state of the clamping device 1 as it is after releasing M3.3 of the spring unit 30 from the preload, whereby the connection area of the two components 2, 3 is pressed together in the clamped state with the predetermined clamping force FK.

The predetermined clamping force FK may be calculated from the spring rate or spring characteristic curve, taking into account the operating point in an initial state of the spring unit 30, a compression stroke of the connecting element 22 and an elongation of the pull rod assembly 20.

The predetermined clamping force FK applied by means of the clamping device 1 shown here has a force flow originating from the pull rod assembly 20 through the guided end section 23 into the spring unit 30. The spring unit 30 supports the predetermined clamping force FK against the upper housing part and transmits it to the lower housing part. The force flow then proceeds through the first assembly aid 61 via the force introduction elements 63, through the two components 2, 3, and through the second assembly aid 62 including its force introduction elements 63. From the second assembly aid 62, the force flow returns via the connecting element 22 to the pull rod assembly 20.

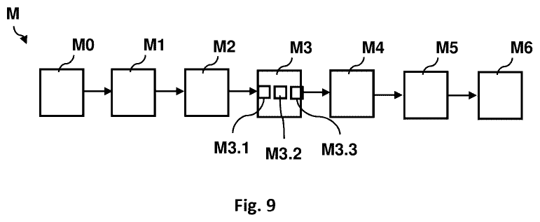

FIG. 9 shows a flowchart of a method M for assembling a structure, particularly in the manufacture of aircraft or spacecraft, according to a further embodiment of the invention.

The method M includes, by way of example, the steps of providing M0 of at least two components 2, 3, applying M1 of a sealant, adhesive or liquid shim to at least one of the components in its connection area, forming M2 of an arrangement by positioning the components relative to each other, clamping M3 of the associated connection areas against each other to achieve a clamped state, maintaining M4 of the clamped state, re-tensioning M5 of the spring unit 30 and disassembling M6 of the connecting element 22.

In step M0, the at least two components 2, 3 are provided, which are to be connected to each other at a connection point to form an assembly, with each of the components 2, 3 having a connection area.

In the optional step M1, the sealant, adhesive or liquid shim may be applied to at least one of the components in its connection area.

In the optional step M2, an assembly may be formed by positioning the components relative to each other, creating an uncured layer of sealant, adhesive, or liquid shim between the associated connection areas. The pull rod assembly 20 may penetrate a recess in the connection area formed by the at least two components 2, 3. The recess allows for the transmission of maximum force, utilizing most of its available cross-section. For example, the pull rod assembly 20 may withstand a load of approximately 6.5 kN when using a UNF 5-44 thread, penetrating a recess with a diameter of approximately 3.3 mm.

In step M3, the associated connection areas are clamped against each other to achieve the clamped state, using at least one clamping device 1. Specifically, the connection areas are clamped by the following steps. A spring unit 30 of the at least one clamping device 1 is pre-tensioned with a predetermined pre-tension force FV (M3.1), whereby a pull rod assembly 20 of the at least one clamping device 1 is pressed into a pre-tensioning position. For example, the spring unit 30 is pre-tensioned using a linear actuator 40 designed as an actuating screw, which is displaceable along the longitudinal axis X by rotation relative to the housing 10, wherein the actuating screw 40 is rotated in a torque-controlled or angle-controlled manner. For example, the spring unit 30 may be pre-tensioned by means of a linear actuator 40. By pre-tensioning the spring unit 30, the spring unit 30 is compressed with approximately 9000 N.

Before or after pre-tensioning M3.1 of the spring unit 30, the pull rod assembly 20 may be installed in an assembly aid 60, which is fixed to one of the components 2, 3 to be connected. The assembly aid 60 is designed to be positively connected to the housing 10 in order to limit the movement of the housing 10 in the direction of the longitudinal axis X in the event of a failure. This prevents the housing from jumping away due to the pre-tensioned spring unit in the event of a failure, for example, a breakage of the pull rod assembly. The housing may be rotated about its longitudinal axis to establish a positive connection between the assembly aid and the housing. The positive connection between the assembly aid and the housing may be established, for example, using a bayonet fitting. In particular, the housing may have a positive locking element projecting perpendicular to the longitudinal axis, which may be inserted into an angled groove of the mounting aid, for example, by rotating the housing by 90°or less. That is, the housing may be rotated by a quarter turn or less to fully lock it in the mounting aid and allow further insertion, enabling the installation of the fastener. The positive locking element may prevent rotation of the housing during torque operations of the fastener and/or the linear actuator. Specifically, after rotation, the housing may be pushed further through, thus exposing the free end region 21 and allowing the combination nut 22 to be screwed on.

Furthermore, a connecting element 22 of the pull bar assembly 20 is fixed in relation to a guided end region 23 of the pull bar assembly 20 M3.2, so that the associated connecting areas between a housing 10 of the at least one clamping device 1 and the connecting element 22 may be clamped. In addition, the connecting areas are clamped by releasing the spring unit 30 from its preload M3.3, whereby the associated connecting areas are pressed together in the clamped state with a predetermined clamping force FK.

In the optional step M4, the clamped state of the associated connection areas may be maintained at least until the layer of sealant between and in contact with the associated connection areas has cured to a predefined degree, whereby the clamping device may be installed and transported together with the assembly.

Once the layer of sealant, adhesive, or liquid shim has cured at least to a predefined degree, at least a plurality of fastening positions may be drilled within the joint areas to create a hole of final dimensions at each of these fastening positions. Furthermore, a final fastener may be installed at each of these fastening positions. This occurs when the sealant, adhesive, or liquid shim has cured to a predefined degree, corresponding to a cure level at which the sealant, adhesive, or liquid shim no longer flows and, without external mechanical action, the joint areas remain unchanged in their spatial arrangement relative to each other at the predefined cure level.

In the optional step M5, the spring unit 30 of the at least one clamping device 1 is re-preloaded with the predetermined preload force FV before the fastener 22 is disassembled M6 to relieve the tension on the pull rod assembly 20. This allows the predetermined clamping force FK acting on the pull rod assembly 20 to be reduced or eliminated, as otherwise it would be nearly impossible to remove the fastener 22, especially the nut, with a standard torque. Alternatively, the fastener 22 could be completely released by means of a groove to allow for removal. Step M5 may be performed in the same way as step M3.1.

In the optional step M6, the connecting element 22 is disassembled relative to the guided end region 23 of the pull rod assembly 20, while the pull rod assembly 20 is held in the preparation position. This means that, for disassembly in step M6, the linear actuator 40 must push the pull rod assembly 20 into the preparation position, in particular, the actuating screw must be screwed in until it reaches the stop element 11 of the housing 10. The correct preparation position may be checked by the maximum torque of the actuating screw 40, by the position of the actuating screw, or by a recess in the housing 10.

After disassembly M6 of the connecting element 22, the at least one clamping device 1 may be used in the next application. In particular, after disassembly M6 of the connecting element 22, the spring unit 30 may remain pre-tensioned with the predetermined preload force FV M3.1; M5, with the pull bar assembly 20 being held in the preparation position. In this case, step M3.1 corresponds to step M5, and it is possible to proceed with step M3.2.

The process steps described above may preferably be carried out in the order in which they are mentioned or numbered, but are not limited to this order.

In the preceding detailed description, various features have been summarized in one or more examples to improve the clarity of the presentation. However, it should be clear that the above description is merely illustrative and in no way limiting. It serves to cover all alternatives, modifications, and equivalents of the various features and embodiments. Many other examples will be immediately and directly clear to the person skilled in the art based on their technical knowledge, given the above description.

The exemplary embodiments were selected and described to best illustrate the principles underlying the invention and its practical applications. This enables those skilled in the art to optimally modify and utilize the invention and its various exemplary embodiments with regard to the intended purpose. In the claims and the description, the terms “including” and “comprising” are used as neutral language terms for the corresponding terms “comprehensive.” Furthermore, the use of the terms “a,” “a,” and “an” is not intended to fundamentally exclude multiple features and components described in this way.

While at least one exemplary embodiment of the present invention(s) is disclosed herein, it should be understood that modifications, substitutions and alternatives may be apparent to one of ordinary skill in the art and may be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMBER LIST

1 clamping device
2, 3 two components to be connected
10 cases
11 Lifting equipment
12—disc assembly
13 axial needle bearings
14 Positive locking element
15 visualization tools for visualizing the correct predetermined preload force
16 Damping ring
20 pull rod assembly
21 free end area of the pull rod assembly
22 Fasteners
23 guided end area of the pull rod assembly
24 external threads
30 spring unit
40 Linear actuator
41 Stop ring
50 Spring assembly
60 Assembly aid
61 first assembly aid part
62 second assembly aid part
63 force introduction elements
FK predetermined clamping force
FV predetermined spring preload
X Longitudinal axis
M procedure
M0 Providing at least two components
M1 Applying a sealant, adhesive or liquid shim
M2 Forming an arrangement
M3 terminals of the associated connection areas
M3.1 Preloading a spring unit
M3.2 Fixing a fastener
M3.3 Releasing the spring unit
M4 Maintaining the clamped state
M5 Re-tensioning the spring unit
M6 Disassembling the fastener

Claimed is:

1. A clamping device for clamping at least two components of a structure with a predetermined clamping force, the clamping device comprising:
a housing with a longitudinal axis;
a pull rod assembly having a free end region and a guided end region, wherein the guided end region is configured to be slidably mounted in the housing along the longitudinal axis, wherein the free end region has a connecting element which is integrally connected to the pull rod assembly by friction, or form locking, or both, and wherein the connecting element is fixed in relation to the guided end region in such a way that two components of a structure to be connected to each other are clamped between the housing and the connecting element;
a spring unit arranged in the housing and configured to be compressed or decompressed by moving the guided end region relative to the housing; and,
a linear actuator configured to push the pull rod assembly into a preparation position in which the spring unit is preloaded with a predetermined preload force.

2. The clamping device according to claim 1, wherein the pull rod assembly has a tensile strength of about 1900 MPa or more.

3. The clamping device according to claim 1, wherein the pull rod assembly has an external thread.

4. The clamping device according to claim 3, further comprising:
a spring device for checking an initial position of the connecting element by screwing the connecting element using the external thread.

5. The clamping device according to claim 1, wherein the linear actuator comprises an actuating screw which is configured to be displaced along the longitudinal axis by turning relative to the housing.

6. The clamping device according to claim 1, wherein the guided end region in the preparation position is in contact with a stop element of the housing,
wherein the stop element is positioned such that the spring unit is compressed by a displacement of the guided end region relative to the housing which causes the predetermined preload force.

7. The clamping device according to claim 1, wherein the guided end region is coupled to the linear actuator via a rotatable disc assembly.

8. The clamping device according to claim 1, further comprising:
an assembly aid configured to be fixed to one of the two components to be connected to each other,
wherein the assembly aid is configured to positively interlock with the housing in order to limit a freedom of movement of the housing in a direction of the longitudinal axis in an event of a fault.

9. A method for assembling a structure, the method comprising:
providing at least two components to be connected to each other at a connection point to form an assembly, each of the components of the at least two components having a connection area; and,
clamping the connection areas of the at least two components against each other to achieve a clamped state with at least one clamping device, and wherein the clamping comprises:
preloading a spring unit of the at least one clamping device with a predetermined preload force, wherein a pull rod assembly of the at least one clamping device is pressed into a preparation position,
fixing a connecting element of the pull rod assembly in relation to a guided end region of the pull rod assembly so that the connecting areas are clamped between a housing of the at least one clamping device and the connecting element, and
releasing the spring unit from the predetermined preload force, whereby the connection areas are pressed together in the clamped state with a predetermined clamping force.

10. The method according to claim 9, wherein the spring unit is pre-tensioned by a linear actuator comprising an actuating screw configured to be displaced along a longitudinal axis of the housing by rotation relative to the housing, wherein the actuating screw is rotated in a torque-controlled or angle-controlled manner.

11. The method according to claim 9, further comprising:
before the connecting element is disassembled, re-tensioning the spring unit of the at least one clamping device with the predetermined preload force to relieve the pull rod assembly.

12. The method according to claim 11, further comprising:
disassembling the connecting element in relation to the guided end region of the pull rod assembly, holding the pull rod assembly in the preparation position.

13. The method according to claim 9, wherein the pull rod assembly penetrates a recess of the at least two components in the connection areas.

14. The method according to claim 9, wherein the pull rod assembly is installed in an assembly aid fixed to one of the at least two components,
wherein the assembly aid is configured to be positively connected to the housing in order to limit a freedom of movement of the housing in a direction of a longitudinal axis of the housing in an event of a fault.

15. The method according to claim 9, further comprising:
applying a sealant, an adhesive or a liquid shim to at least one of the at least two components in the connection area.
